(19) United States
(12) Patent Application Publication
(10) Pub. No.: US 2017/0288383 A1
(43) Pub. Date: Oct. 5, 2017

(54) Cable Connector Accessory Assemblies and Methods for Connecting Cables to Cable Connector Accessories

(71) Applicant: AFL Telecommunications LLC, Duncan, SC (US)

(72) Inventor: Wayne Lawrence Quesnel, Moore, SC (US)

(73) Assignee: AFL Telecommunications LLC

(21) Appl. No.: 15/090,893

(22) Filed: Apr. 5, 2016

(51) Int. Cl. H02G 7/05; H02G 15/08; H02G 1/14

(52) U.S. Cl. CPC H02G 7/056; H02G 1/14; H02G 15/08

(57) ABSTRACT

Methods for connecting cables and cable connector accessories include inserting an end portion of the cable into a bore defined in a main body of the cable connector accessory, the cable connector accessory formed from an aluminum. Methods further include detonating an explosive, the explosive comprising a detonation cord surrounding an outer surface of the main body of the connector accessory. Detonation of the explosive compresses the main body around the end portion of the cable.

### FIELD OF THE INVENTION

The present disclosure relates generally to cable connector accessories assemblies which include cable connector accessories such as dead ends or splices, and to methods for connecting cables to cable connector accessories.

### BACKGROUND OF THE INVENTION

Cables are utilized in a variety of environments and for a variety of applications, including the transmission of electricity, light and/or other signals. Cable connector accessories are utilized to connect the cables to other cables or to other components of the energy transmission assembly such as other cable connector accessories or the tower. Examples of cable connector accessories include dead ends, splices, terminals, repair sleeves, t-taps, t-connectors, jumper connectors, etc.

In many cases, such as in the case of overhead ground wire cables, the cables are installed in relatively high tension. Due to the relatively high tension environments, it is desirable for the connection between a cable connector accessory and cable to be robust, thereby preventing relative movement between the cable and cable connector accessory and/or disconnection of the cable from the cable connector accessory.

In some cases, explosives have been utilized to connect cables and cable connector accessories. Detonation of the explosive compresses various components of an assembly, resulting in a connection of the cable to the cable connector accessory. However, in some cases, the required amount of explosive to obtain the required compression to connect to a cable is undesirably high, resulting in increased heat, noise, and pressure wave during detontation, as well as increased associated labor. In other cases, additional components such as intermediate sleeves and additional steps such as stripping of portions of the cables are required to facilitate the desired cable connection.

Accordingly, improved cable connector accessory assemblies and methods for connecting cable connector accessories and cables together are desired. In particular, assemblies and methods which are relatively simple and cost-effective, and which require relatively less explosive, would be advantageous.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a cable connector accessory assembly is provided. The cable connector accessory assembly includes a cable connector accessory. The cable connector accessory is formed from an aluminum and includes a main body defining a bore. The main body includes an outer surface and an inner surface. The inner surface defines the bore. The cable connector accessory assembly further includes a grit coating disposed on the inner surface, and an interface material surrounding and in contact with the outer surface of the main body. The cable connector accessory assembly further includes an explosive, the explosive including a detonation cord surrounding the outer surface of the main body and in contact with the interface material.

In accordance with another embodiment of the present disclosure, a method for connecting a cable and a cable connector accessory is provided. The method includes inserting an end portion of the cable into a bore defined in a main body of the cable connector accessory. The cable connector accessory is formed from an aluminum. The method further includes detonating an explosive, the explosive comprising a detonation cord surrounding an outer surface of the main body of the connector accessory. Detonation of the explosive compresses the main body around the end portion of the cable.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a side view of a cable connector accessory assembly in accordance with one embodiment of the present disclosure;

FIG. 2 is a top cross-sectional view of the cable connector accessory assembly of FIG. 1;

FIG. 3 is a top cross-sectional view of a cable connector accessory assembly with a cable disposed in a bore thereof in accordance with one embodiment of the present disclosure;

FIG. 4 is a top cross-sectional view of a connected cable connector accessory and cable after detonation of an explosive in accordance with one embodiment of the present disclosure;

FIG. 5 is a side cross-sectional view of a cable connector accessory assembly in accordance with another embodiment of the present disclosure;

FIG. 6 is a side cross-sectional view of a cable connector accessory assembly in accordance with another embodiment of the present disclosure;

FIG. 7 is a side view of a cable connector accessory assembly in accordance with another embodiment of the present disclosure;

FIG. 8 is a side cross-sectional view of the cable connector accessory assembly of FIG. 7;

FIG. 9 is a side cross-sectional view of a cable connector accessory assembly with cables disposed in bores thereof in accordance with another embodiment of the present disclosure;

FIG. 10 is a side cross-sectional view of a connected cable connector accessory and cables after detonation of an explosive in accordance with another embodiment of the present disclosure;

FIG. 11 is a perspective view of a cable in accordance with one embodiment of the present disclosure;

FIG. 12 is a perspective view of a cable in accordance with another embodiment of the present disclosure; and

FIG. 13 is a flow chart illustrating a method for connecting a cable and a cable connector accessory in accordance with embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The present disclosure relates generally to cable connector accessory assemblies and methods for connecting cables and cable connector accessories together. Assemblies and methods in accordance with the present disclosure advantageously facilitate improved connections between the cables and cable connector accessories. A cable connector accessory is compressed onto a cable via detonation of an explosive. The compressive explosive force and resulting compression causes the improved connection. For example, resulting cable connector accessories connected to cables in accordance with the present disclosure may maintain their connections at loads of greater than or equal to 95% of the ultimate tensile strength of the cable. Additionally, the outer surface of the cable connector accessory may have a relatively smooth, undamaged surface after detonation and the resulting connection. Further, relatively little explosive is required for detonation and resulting connections in accordance with the present disclosure. The use of relatively little explosive advantageously results in less noise, heat and pressure wave during detontation, and results in relatively less associated labor. The advantageous use of aluminum cable connector accessories, as discussed herein, facilitates improved connections with the use of relatively less explosive.

In exemplary embodiments, cable connector accessories and assemblies in accordance with the present disclosure are utilized with overhead ground wire cables. Alternatively, however, any suitable cables may be utilized. Examples of suitable cable connector accessories include, for example, dead ends, splices, terminals, repair sleeves, t-taps, t-connectors, jumper connectors, and other suitable connector accessories for connecting cables to other cables or to other components of an energy transmission assembly such as other cable connector accessories or a tower.

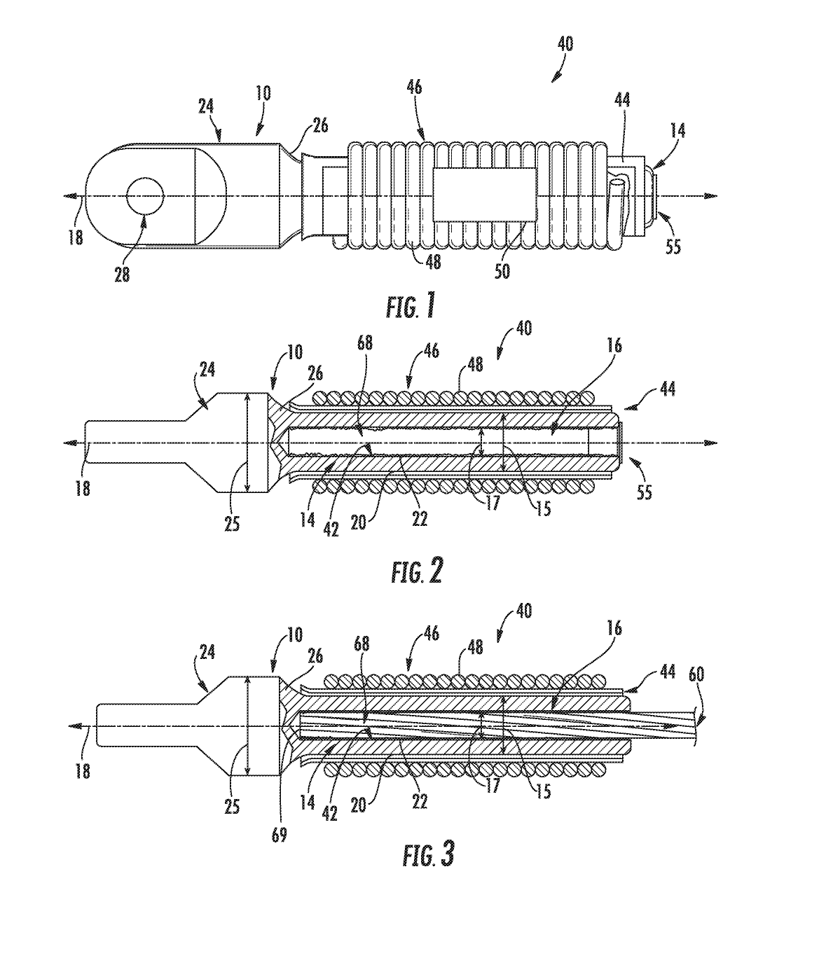

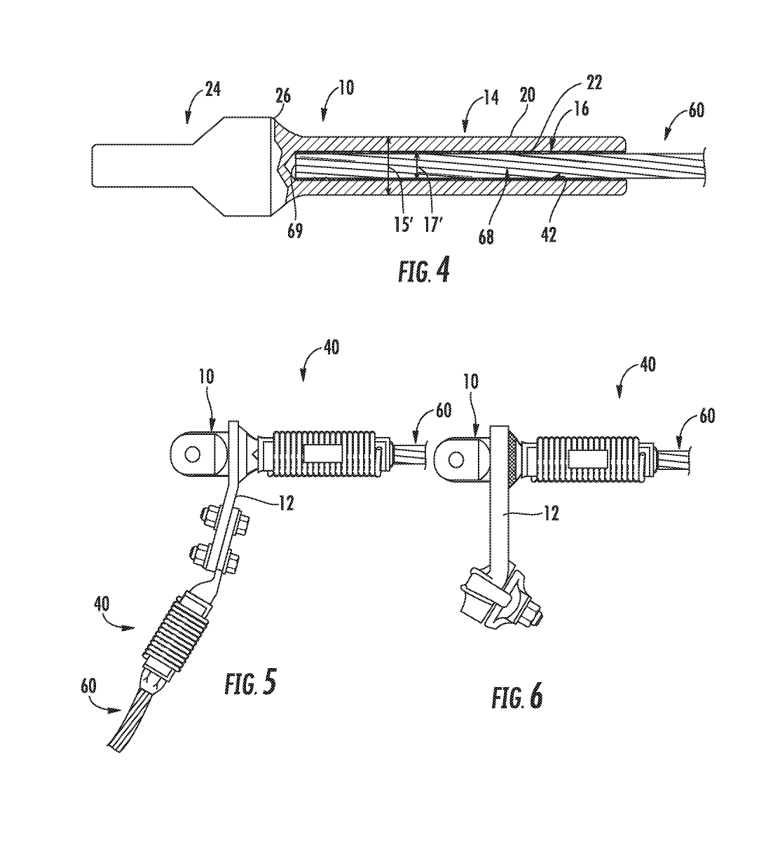

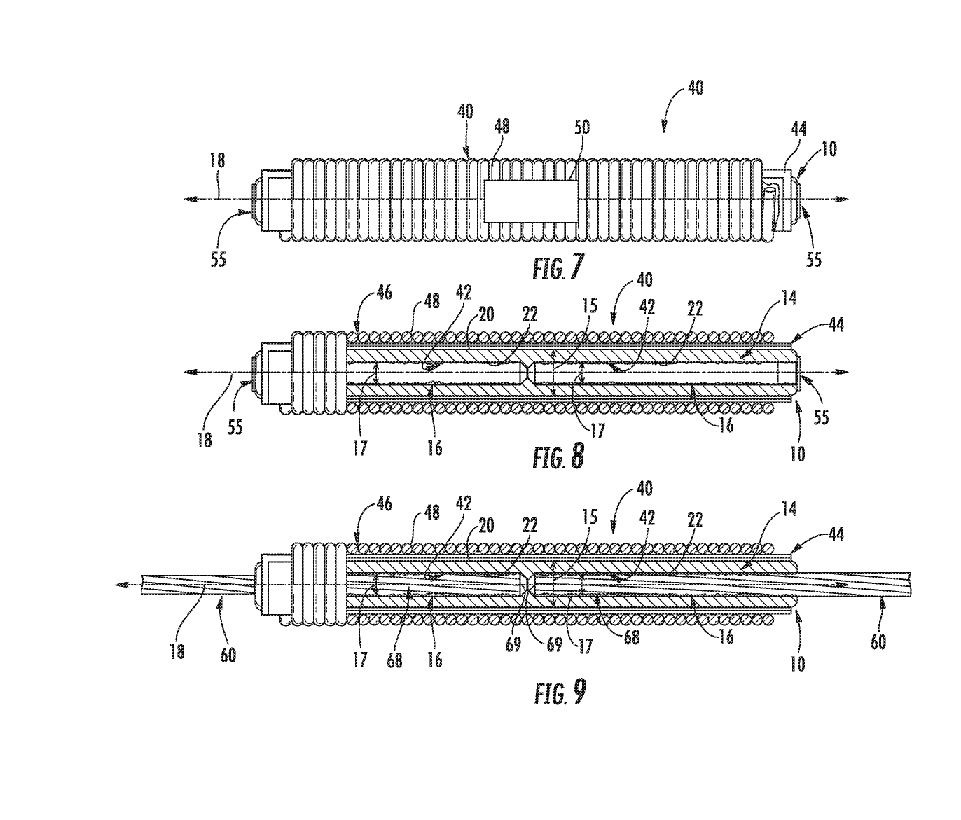

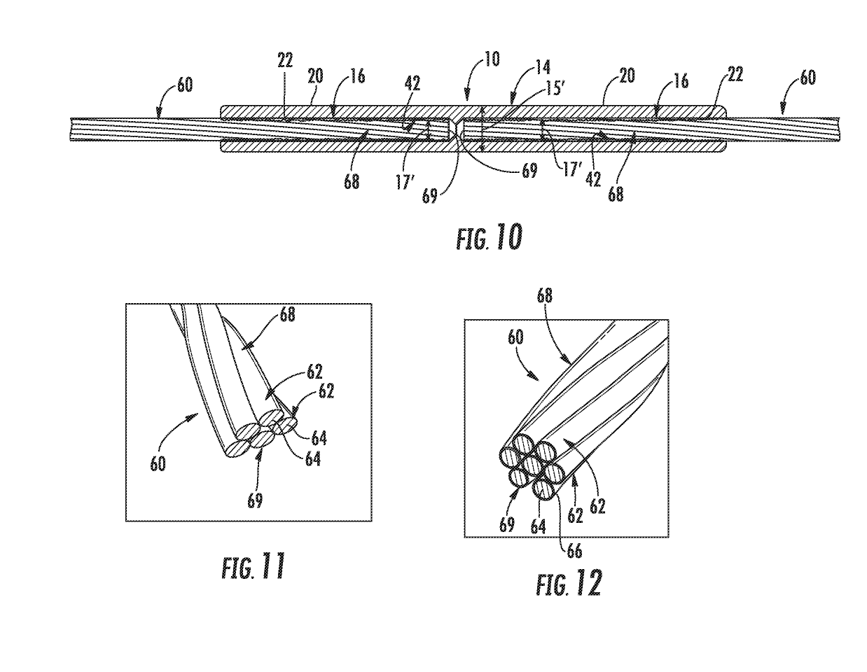

Referring now to FIGS. 1 through 10, embodiments of cable connector accessories 10 in accordance with the present disclosure are provided. FIGS. 1 through 6 illustrate embodiments wherein the cable connector accessory 10 is or includes a dead end. FIGS. 7 through 10 illustrate embodiments wherein the cable connector accessory 10 is a splice. As illustrated in FIGS. 5 and 6, in some embodiments, additional cable connector accessories 10 may be coupled to the cable connector accessory 10. For example, FIG. 5 illustrates a terminal connected to a dead end via a bolted connection to a tongue 12 of the dead end. As shown, the dead end and terminal may both be connected to cables via use of cable connector accessory assemblies and detonation of explosives thereof in accordance with the present disclosure. FIG. 6 illustrates a jumper connector that is welded onto or integral (i.e. integrally formed as a single unitary component) with a tongue 12 of the dead end.

A cable connector accessory 10 in accordance with the present disclosure may include a main body 14 in which one or more bores 16 may be defined. A bore 16 may, for example, extend into the main body 14 through a sidewall thereof and along a longitudinal axis 18 of the main body 14. Main body 14 may further include an outer surface 20 and one or more inner surfaces 22. An inner surface 22 may define an associated bore 16.

The main body 14 may, for example, have a maximum width 15 that is greater than or equal to 0.75 inches, such as greater than or equal to 1 inch, such as greater than or equal to 1.25 inches, such as greater than or equal to 1.75 inches. The bore 16 may have a maximum width 17 that is greater than or equal to 0.25 inches, such as greater than or equal to 0.3 inches, such as greater than or equal to 0.4 inches, such as greater than or equal to 0.45 inches.

In some embodiments, such as wherein the cable connector accessory 10 is a splice, the cable connector accessory 10 may generally include only the main body 14. In these embodiments, for example, accessory 10 may include two bores 16, into each of which a cable may be provided for connection to the accessory 10 and resulting connection of the cables together. Notably, the bores 16 may be partitioned and thus generally isolated from each other. In some exemplary embodiments, the bores 16 may have approximately equal lengths to allow equal lengths of cable to be inserted therein.

In alternative embodiments, such as wherein the cable connector accessory 10 is a dead end or terminal, the cable connector accessory 10 may include additional components. For example, as illustrated in FIGS. 1 through 6 and in particular in embodiments wherein the accessory 10 is a dead end, an end body 24 may extend from the main body 14, such as along the longitudinal axis 18. A radiused portion 26 may provide a transition between the main body 14 and end body 24. The end body 24 may, for example, have a maximum width (i.e. a maximum diameter) 25 that is greater than a maximum width 15 of the main body 14. For example, the end body 24 may have a maximum width 25 that is greater than or equal to 1 inch, such as greater than or equal to 1.25 inches, such as greater than or equal to 1.5 inches, such as greater than or equal to 2.125 inches. An aperture 28 may be defined in the end body 24, through which additional components such as a shackle (not shown) may be coupled to the end body 24 and accessory 10 generally.

Additionally or alternatively, a cable connector accessory 10 may include a tongue 12. The tongue 12 may facilitate a connection with another cable connector accessory 10, as discussed above and illustrated in FIGS. 5 and 6.

One or more components of the cable connector accessory 10 may be integral with each other. For example, the main body 14 and end body 24 may be integral. The tongue 12 may be integral with the main body 14 and/or end body 24, or alternatively may be welded to the main body 14 and/or end body 24.

Cable connector accessories 10 in accordance with the present disclosure are formed from aluminum. Accordingly, the main body 14, as well as the end body 24 and tongue 12, may be formed from aluminum. It should be understood that the term aluminum encompasses both pure aluminum and aluminum alloys. The use of aluminum advantageously facilitates improved connections with cables as discussed herein due to its advantageous characteristics when compressed due to explosive detonation as discussed herein.

A cable connector accessory 10 is a component of a cable connector accessory assembly 40 which may be utilized to connect the cable connector accessory 10 to a cable. FIGS. 1 through 3 and 5 through 9 further illustrate embodiments of cable connector accessory assemblies 40.

An assembly 40 may further include a grit coating 42. The grit coating 42 may be disposed on the inner surface(s) 22 defining the bore(s) 16 of a cable connector accessory 10, and may facilitate improved gripping of the cable connector accessory 10 on the cable. The grit coating 42 may include a plurality of particles, such as in exemplary embodiments silicon carbide particles. The grit coating 42 may further include a varnish or other suitable adhesive in which the particles may be embedded, and which may provide a connection between the particles and the inner surface(s) 22.

Assembly 40 may further include an interface material 44. The interface material 44 may protect the accessory 10, and in particular the main body 14 thereof, from damage due to detonation of the explosive to connect the accessory 10 and a cable. The interface material 44 may, for example, be formed from a heat-shrink material which may for example be translucent or transparent. In exemplary embodiments, the interface material 44 may be formed from a plastic, which may for example be a polyvinyl chloride. One example of such material is Insultab HS-105 heat-shrink tubing material.

The interface material 44 may surround the main body 14, such as the outer surface 20 thereof, and may contact the outer surface 20. One or more layers of interface material 44 may be provided in the assembly 40, with one layer contacting the outer surface 20 and additional layers on the initial layer. For example, in exemplary embodiments, only two layers of interface material 44 may be utilized. Alternatively, one, three or more layers of interface material 44 may be utilized.

Assembly 40 may further include an explosive 46. The explosive 46 may include a detonation cord 48, and may further include a detonator 50. The detonation cord 48 may surround the main body 14, such as the outer surface 20 thereof. For example, the detonation cord 48 may contact the interface material 44, such as an outer layer of the interface material 44. One or more layers of detonation cord 48 may be wrapped around the main body 14. However, in exemplary embodiments, only a single layer or only two layers of detonation cord 48 may be required to surround the main body 14 and outer surface 20 thereof for the explosion to be sufficient to connect the accessory 10 and cable.

In exemplary embodiments, the detonation cord 48 may be formed from or include pentaerythritol tetranitrate. Alternatively, other suitable explosive materials may be utilized. The detonation cord 48 may further have a weight of greater than 50 grains per foot, such as greater than 75 grains per foot, such as between 50 and 150 grains per foot, such as between 75 and 125 grains per foot, such as in exemplary embodiments 100 grains per foot.

Any suitable detonator 50 may be utilized. The detonator may be connected to the detonation cord 48, such that activation and explosion of the detonator 50 causes detonation of the detonation cord 48.

It should additionally be noted that a cable connector accessory assembly 40 may include a cap 55. The cap 55 may be provided to plug an end of the bore 16, thus reducing or preventing the entry of contaminates into the bore 16 and generally protecting the bore 16. The cap 55 may be provided to plug the bore 16 for transportation before connection to a cable, and may be removed for insertion of a cable therein and subsequent explosion to connect the cable and cable connector accessory 10.

As discussed, the present disclosure is further directed to methods for connecting cables and cable connector accessories. Referring again to FIGS. 1 through 10, various embodiments of cable connector accessories 10 and cable connector accessory assemblies 40, components of which may be utilized to connect cables and cable connector accessories 40, are illustrated. Referring to FIGS. 3 through 6 and 9 through 12, embodiments of cables 60 in accordance with the present disclosure are illustrated.

In general, any suitable cables 60 may be connected to cable connector accessories 10 in accordance with the present disclosure. In exemplary embodiments, for example, a cable 60 in accordance with the present disclosure is an overhead ground wire cable.

A cable 60 may, for example, include a plurality of cable strands 62 which are arranged in one or more generally concentric layers. For example, in some embodiments as shown, a cable 60 may include seven cable strands 62, with a central strand 62 surrounded by a layer of six strands 62. In other embodiments, a cable 60 may include more than seven cable strands 62, such as 19, 37, 49, etc., with the additional cable strands 62 provided in one or more additional layers. One or more layers, such as the layer of six strands 62 surrounding the central strand 62, may have a helical arrangement, with each strand 62 extending helically about a longitudinal axis of the cable 60.

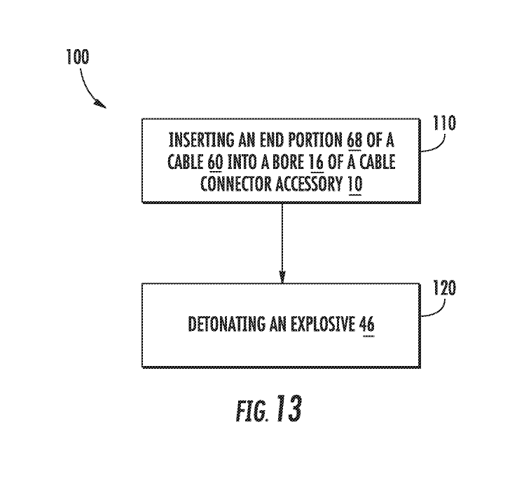

In exemplary embodiments, the cable strands 62 of cable 60 are formed from one or more metals. For example, in some embodiments, each cable strand 62 is formed from a steel and/or an aluminum. In some embodiments, as illustrated in FIG. 11, each cable strand 62 is formed entirely from a single material, i.e. a single metal such as a steel. Additionally or alternatively, other suitable materials such as polymers, glasses, etc. may be utilized. In other embodiments, as illustrated in FIG. 12, each cable strand 62 is formed from multiple layers of different materials, i.e. different metals such as a steel and an aluminum. For example, a cable strand 62 may include a core 64, as illustrated in FIGS. 11 and 12, and may in some embodiments further include a cladding 66 surrounding the core 64, as illustrated in FIG. 12. The core 64 may be formed from one material, i.e. a metal such as steel as illustrated in FIGS. 11 and 12. The cladding 66 may be formed from another material, i.e. an aluminum as illustrated in FIG. 12.

Referring now to FIGS. 3 through 6, 9 through 10 and 13, a method 100 for connecting a cable 60 and cable connector accessory 10 may include, for example, the step 110 of inserting an end portion 68 of a cable 60 (which includes an end 69 of the cable 60) into a bore 16 of a cable connector accessory 10. One or more cables 60 may be inserted into a respective one or more bores 16 of a cable connector accessory 10, depending on the cable connector accessory 10 utilized. When in the bore 16, a cable 60 may contact the grit coating 42 and/or inner surface 22 of the bore 16.

Method 100 may further include, for example, the step 120 of detonating an explosive 46. As discussed, the explosive 46 includes detonation cord 48, which may surround the outer surface 20 of a main body 14 of the cable connector accessory 10. Detonation of the explosive 46, and particularly the detonation cord 48 thereof, may exert a compressive force onto the main body 14, compressing the main body 14 around the end portion 68 of the cable 60. This compression may connect the cable 60 and cable connector accessory 10 together. FIGS. 4 and 10 illustrate embodiments of a connected cable connector accessory 10 and cable 60 after detonation of the explosive 46. Due to compression as discussed, the maximum widths of the main body 15′ and/or bore 17′ may be less than the maximum widths 15 and/or 17 before such detonation. Notably, the grit coating 42 may further facilitate a strong connection between the cable 60 and cable connector accessory 10. Additionally, the interface material 44 may be vaporized during the explosion, and may during the explosion create an air gap which provides a cushion such that the outer surface 20 of the main body 14 is not damaged by the explosion. Further, in embodiments wherein an end body 24 is included, the radiused portion 26 may act as a relief for the pressure wave generated during the explosion, thus reducing or eliminating pitting and other damage to the end body 24.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method for connecting a cable and a cable connector accessory, the method comprising:
inserting an end portion of the cable into a bore defined in a main body of the cable connector accessory, the cable connector accessory formed from aluminum, wherein a grit coating is disposed on an inner surface of the main body defining the bore and an interface material surrounds and contacts an outer surface of the main body; and
detonating an explosive, the explosive comprising a detonation cord surrounding an outer surface of the main body of the connector accessory,
wherein detonation of the explosive compresses the main body around the end portion of the cable.

2. The method of claim 1, wherein the detonation cord is disposed in a single layer or only two layers surrounding the outer surface.

3. The method of claim 1, wherein the interface material formed from plastic.

4. The method of claim 3, wherein the plastic is polyvinyl chloride.

5. (canceled)

6. The method of claim 1, wherein the grit coating is formed from silicon carbide particles.

7. The method of claim 5, wherein the end portion of the cable contacts the grit coating when the end portion of the cable is inserted into the bore.

8. The method of claim 1, wherein the cable is an overhead ground wire cable.

9. The method of claim 1, wherein the cable comprises a plurality of cable strands, each of the plurality of cable strands comprising a steel core.

10. The method of claim 9, wherein each of the plurality of cable strands further comprises an aluminum cladding surrounding the steel core.

11. The method of claim 1, wherein the cable connector accessory is a dead end.

12. The method of claim 1, wherein the cable connector accessory is a splice.

13-20. (canceled)
